(19) United States
(12) Patent Application Publication
(10) Pub. No.: US 2017/0244952 A1
(43) Pub. Date: Aug. 24, 2017

(54) METHOD FOR MEASURING DEPTH OF FIELD OF IMAGE AND IMAGE PICKUP DEVICE AND ELECTRONIC DEVICE USING THE SAME

(71) Applicant: Primax Electronics Ltd., Neihu (TW)

(72) Inventor: JUI-TING CHIEN, Neihu (TW)

(21) Appl. No.: 15/088,713

(22) Filed: Apr. 1, 2016

(30) Foreign Application Priority Data
Feb. 19, 2016 (TW) 105105023

(51) Int. Cl. H04N 13/02

(52) U.S. Cl. CPC H04N 13/021; H04N 5/2259

(57) ABSTRACT

The present invention provides a method for measuring depth of field of an image, including: (a) picking up a first image at a first position; (b) driving the optical lens to move to a second position in a direction along a non-optical axis, and picking up a second image at the second position; and (c) obtaining depth-of-field data of either the first image or the second image by using a difference between the first image and the second image. In addition, the present invention also provides an image pickup device and an electronic device using the method.

### FIELD OF THE INVENTION

The present invention relates to the field of image optics, and more particularly to a method for measuring depth of field of an image and an image pickup device and an electronic device using the same.

### BACKGROUND OF THE INVENTION

In recent years, with evolution of electronic industries and flourish of industrial technologies, design and development of various electronic devices are oriented to the direction of light and easy to carry, so as to make it convenient for a user to use same in mobile business, entertainment or recreation, and the like anytime and anywhere. For example, various image pickup devices are widely used in various fields, for example, in electronic devices such as smart phones, wearable electronic devices, and air shoot devices, which have advantages of having a small volume and being easy to carry, so that a user can take out the same any time when there is a use demand, to pick up an image and store the image, or further upload the image to the Internet via a mobile network. This not only has a significant commercial value, but also further enriches people's daily life. However, with the improvement of life quality, people have more demands for images, and more particularly expect that an obtained image has a higher imaging quality and more imaging effects.

For example, referring to FIG. 1, FIG. 1 is a schematic structural diagram illustrating an appearance of an existing smart phone. Two optical lenses 11 and 12 that are arranged in parallel to each other are disposed on a smart phone 1. The two optical lenses 11 and 12 may photograph the same environment from different angles. Therefore, a three-dimensional image having depth-of-field data may be obtained through analysis and computation on two images that are respectively picked up by the two optical lenses 11 and 12. At present, manufactures such as HTC, SONY, LG, and Huawei all provide products similar to the smart phone 1 having double lenses 11 and 12. Therefore, the technology of obtaining depth-of-field data by using double optical lenses 11 and 12 is well known by those ordinarily skilled in the art, which is not described in detail again herein.

However, to dispose two optical lenses on a smart phone for obtaining depth-of-field data of an image has the following disadvantages: first, the additionally disposed optical lens and a kit thereof lead to increase of a manufacturing cost; second, the additionally disposed optical lens and the kit thereof need to take up a volume, thereby increasing the difficulty for development of smart phones in a trend towards light, thin, short and small. Therefore, there is still room for improvement of the conventional method for obtaining depth-of-field data of an image.

### SUMMARY OF THE INVENTION

An object of the present invention is to provide a method for measuring depth of field of an image, more particularly relates to a method for measuring depth of field of an image capable of obtaining a depth of field of an image by using a single optical lens only, so as to reduce a volume and manufacturing cost of an image pickup device.

Another object of the present invention is to provide an image pickup device and an electronic device using the method for measuring depth of field of an image.

In a preferable embodiment, the present invention provides a method for measuring depth of field of an image, used in an image pickup device having an optical lens, where the method for measuring depth of field of an image includes:

(a) picking up a first image at a first position;

(b) driving the optical lens to move to a second position in a direction along a non-optical axis, and picking up a second image at the second position; and

(c) obtaining a depth-of-field data of either the first image or the second image by using a difference between the first image and the second image.

In a preferably embodiment, the present invention also provides an image pickup device, including:

an optical lens;

a driving unit, connected to the optical lens, configured to drive the optical lens to move from a first position to a second position in a direction along a non-optical axis;

a sensing element, configured to sense a beam that passes through the optical lens and that is transmitted in the sensing element to obtain a first image when the optical lens is located at the first position, and sense a beam that passes through the optical lens and that is transmitted in the sensing element to obtain a second image when the optical lens is located at the second position; and

a computing unit, connected to the sensing element, configured to compute a difference between the first image and the second image to obtain a depth-of-field data of either the first image or the second image.

In a preferably embodiment, the present invention also provides an electronic device, including:

a housing; and

an image pickup device, disposed in the housing, including: an optical lens, at least a part of which is exposed out of the housing;

a driving unit, connected to the optical lens, configured to drive the optical lens to move from a first position to a second position in a direction along a non-optical axis;

a sensing element, configured to sense a beam that passes through the optical lens and that is transmitted in the sensing element to obtain a first image when the optical lens is located at the first position, and sense a beam that passes through the optical lens and that is transmitted in the sensing element to obtain a second image when the optical lens is located at the second position; and

a computing unit, connected to the sensing element, configured to compute a difference between the first image and the second image to obtain a depth-of-field data of either the first image or the second image.

### BRIEF DESCRIPTION OF THE DRAWINGS

FIG. 1 is a schematic structural diagram illustrating an appearance of an existing smart phone;

FIG. 2 is a concept schematic diagram illustrating an image pickup device of the present invention according to a preferable embodiment;

FIG. 3 is a flow chart illustrating a preferable method of a method for measuring depth of field of an image of the present invention;

FIG. 4 is a concept schematic diagram illustrating actions of an optical lens in the method shown in FIG. 3;

FIG. 5 is a schematic structural diagram illustrating an appearance of an electronic device of the present invention according to a preferable embodiment; and

FIG. 6 is a side elevation illustrating the electronic device shown in FIG. 5.

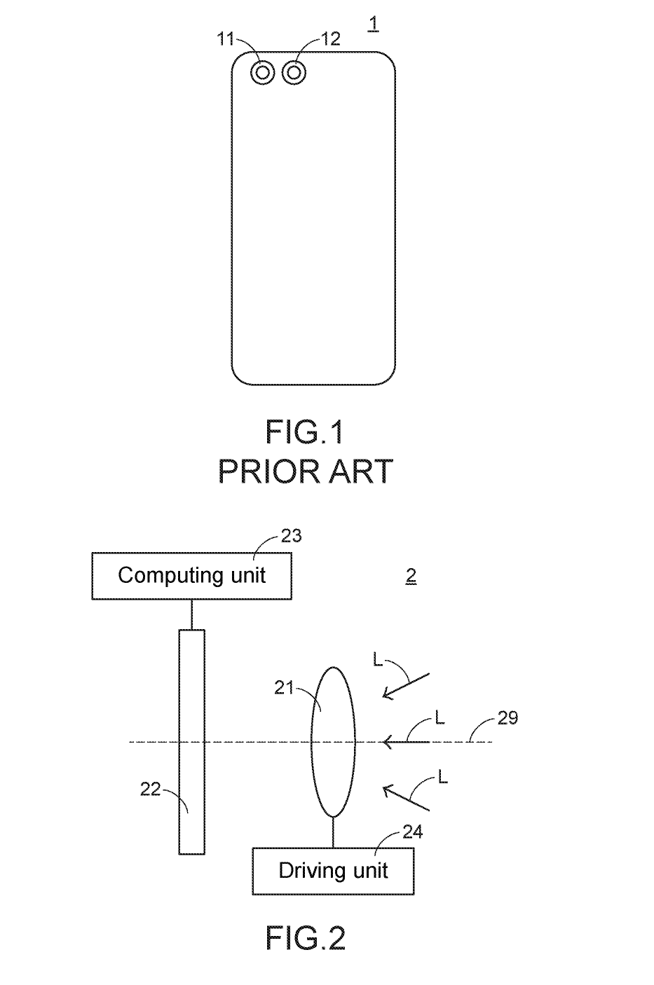

### DETAILED DESCRIPTION OF THE PREFERRED EMBODIMENT

First, an image pickup device of the present invention is illustrated. Referring to FIG. 2, FIG. 2 is a concept schematic diagram illustrating an image pickup device of the present invention according to a preferable embodiment. An image pickup device 2 includes an optical lens 21, a sensing element 22, a computing unit 23, and a driving unit 24. The sensing element 22 is connected to the computing unit 23 and is perpendicular to an optical axis 29. The sensing element 22 is configured to sense a beam L that passes through the optical lens 21 and that is transmitted to the sensing element 22, to obtain an image for analysis and computation by the computing unit 23, and the driving unit 24 is connected to the optical lens 21 and is configured to drive the optical lens 21 to move in a direction D along a non-optical axis (referring to FIG. 4), which are described in detail below. In this preferable embodiment, the driving unit 24 is a motor, and the sensing element 22 is a charge coupled device (CCD) or a complementary metal-oxide-semiconductor (CMOS) member, but the present invention is not limited thereto.

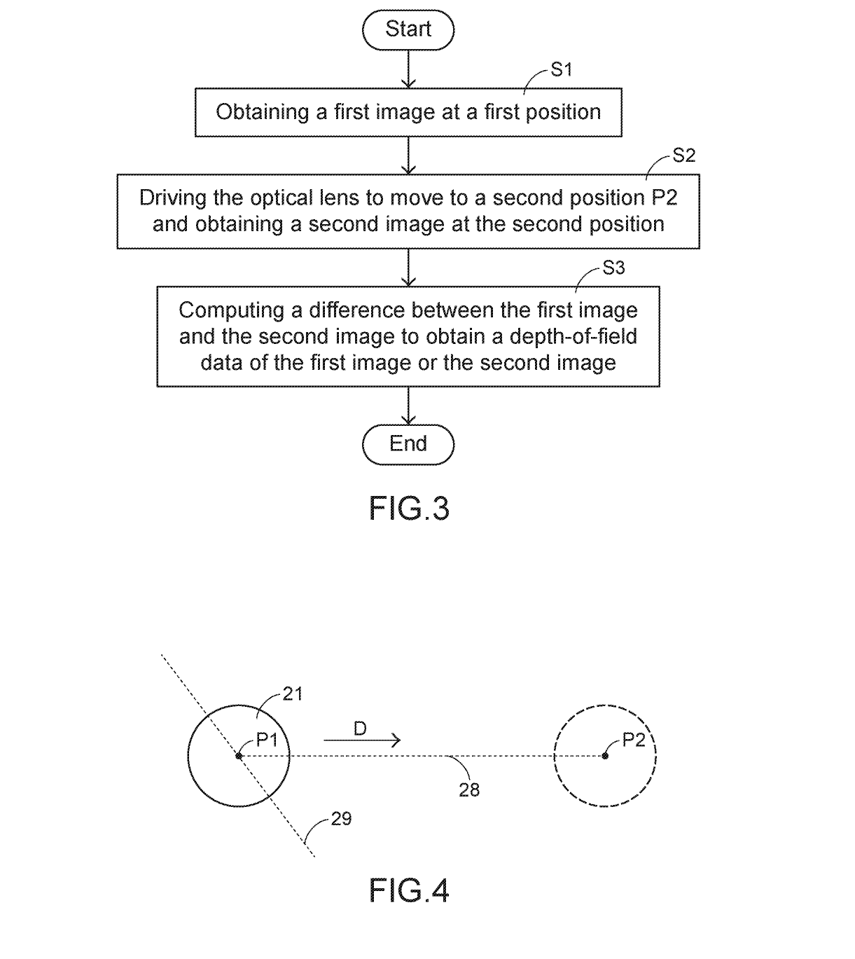

How the image pickup device 2 measures a depth of field is described below. Referring to FIG. 3 and FIG. 4, FIG. 3 is a flow chart illustrating a preferable embodiment of a method for measuring depth of field of an image of the present invention, and FIG. 4 is a concept schematic diagram illustrating actions of an optical lens in the method shown in FIG. 3. The method for measuring depth of field of an image includes step S1 to step S3. Step S1 to step S3 are separately described in detail below.

Step S1: the sensing element 22 senses a beam L that passes through the optical lens 21 and that is transmitted to the sensing element 22 to obtain a first image when the optical lens 21 is located at a first position P1. Step S2: the driving unit 24 drives the optical lens 21 to move from the first position P1 to a second position P2 in a direction D along a non-optical axis, so that the sensing element 22 senses the beam L that passes through the optical lens 21 and that is transmitted to the sensing element 22 to obtain a second image. In this preferable embodiment, the first position P1 and the second position P2 are respectively located at two ends of a maximum tracking distance 28 of the optical lens in the direction D along the non-optical axis, that is, a left limitation position and a right limitation position shown in FIG. 4, but in practical use the present invention is not limited thereto.

Step S3: the computing unit 23 computes a difference between the first image and the second image to obtain a depth-of-field data of the first image or the second image. In this preferable embodiment, the difference between the first image and the second image is obtained by computing a peak signal-to-noise ratio (PSNR). The peak signal-to-noise ratio is an objective standard for evaluating a similarity degree of two images and a higher peak signal-to-noise ratio indicates a smaller image phase difference. However, the above is only an embodiment, and the present invention is not limited thereto. For example, the difference between the first image and the second image may be obtained by using a mean-residual normalized correlation method (ZNCC). In addition, how to obtain depth-of-field data of a first image or a second image by using a difference between the first image and the second image and how to obtain the difference between the first image and the second image by using a peak signal-to-noise ratio or by using a mean-residual normalized correlation method are well known by those ordinarily skilled in the art, which are not described in detail again herein.

In addition, the existing image pickup device 2 generally is provided with an optical image stabilization (OIS) function. That is, a motion sensor (not shown; for example, a gyro) may be disposed in the image pickup device 2, and the driving unit 24 may drive, according to a sensed result by the motion sensor, the optical lens 21 to move, so as to maintain the optical axis 29 to be perpendicular to the sensing element 22, thereby preventing from photographing a fuzzy image. It needs to be specially noted that if the method for measuring depth of field of an image of the present invention is applied to an image pickup device 2 that is originally provided with an optical image stabilization function, the driving unit 24 that is originally disposed in the image pickup device 2 is directly used to drive the optical lens 21 to move from the first position P1 to the second position P2 in the direction D along the non-optical axis in step S2. Therefore, by using the image pickup device 2 that is originally provided with an optical image stabilization function, a function of measuring a depth of field can be provided without additionally disposing a driving unit 24, thereby not increasing the manufacturing cost.

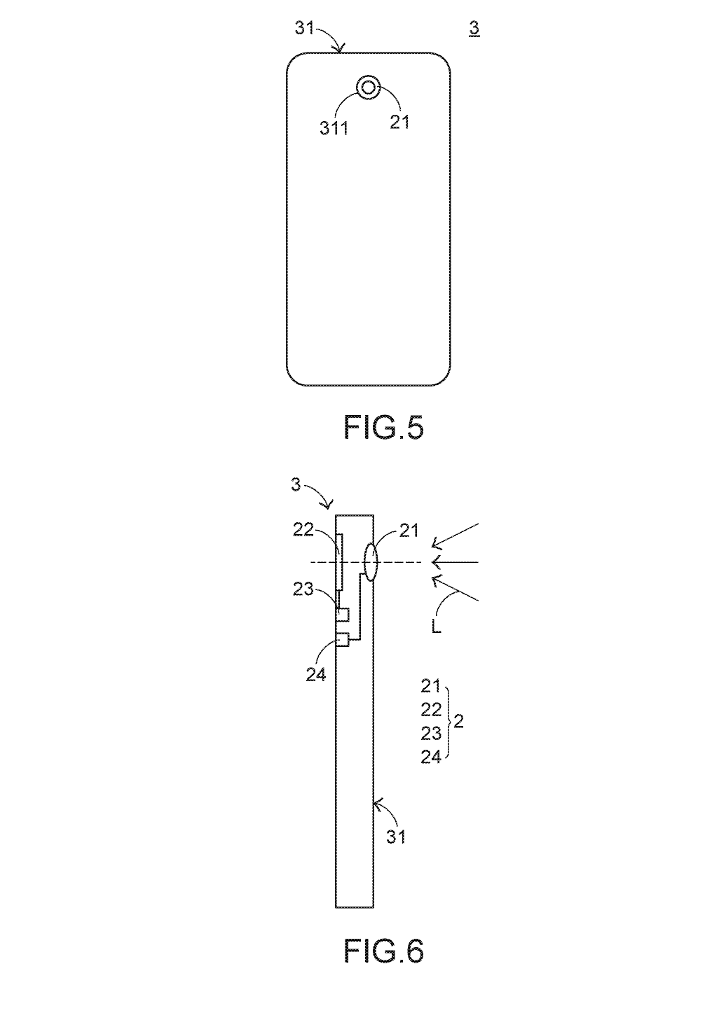

Referring to FIG. 5 and FIG. 6, FIG. 5 is a schematic structural diagram illustrating an appearance of an electronic device of the present invention according to a preferable embodiment, and FIG. 6 is a side elevation illustrating the electronic device shown in FIG. 5. The electronic device 3 is, for example, a mobile phone, a personal digital assistant, or a wearable device (a smart watch, a smart band, or smart glasses), and includes a housing 31 and an image pickup device 2. The housing 31 is provided with a through-hole 311 for exposing the optical lens 21 of the image pickup device 2 outside, so that a beam L outside the housing 31 can be transmitted to the image pickup device 2. The image pickup device 2 of the electronic device 3 shown in FIG. 5 is substantially similar to the one shown in FIG. 2, which is not described in detail again herein.

As can be known from the above, by the method for measuring depth of field of an image and the image pickup device and the electronic device using the same, depth-of-field data can be obtained by using a single optical lens only. Therefore, a manufacturing cost of the image pickup device can be effectively reduced, and meanwhile, a volume of the image pickup device may not be increased by a large margin, which is beneficial to development of an electronic device using an image pickup device in a trend towards light, thin, short and small.

The above are only the most preferred embodiments of the present invention, and the present invention needs not be limited to the disclosed embodiments. Therefore, all equivalent changes or modifications included within the spirit and scope of the present invention fall within the scope of the claims of the present invention.

What is claimed is:

1. A method for measuring depth of field of an image, used in an image pickup device having an optical lens, wherein the method for measuring depth of field of an image comprises:
(a) picking up a first image at a first position;
(b) driving the optical lens to move to a second position in a direction along a non-optical axis, and picking up a second image at the second position; and
(c) obtaining a depth-of-field data of either the first image or the second image by using a difference between the first image and the second image.

2. The method for measuring depth of field of an image according to claim 1, wherein in the step (c), the difference between the first image and the second image is obtained by computing a peak signal-to-noise ratio (PSNR).

3. The method for measuring depth of field of an image according to claim 1, wherein in the step (c), the difference between the first image and the second image is obtained by using a mean-residual normalized correlation method (ZNCC).

4. The method for measuring depth of field of an image according to claim 1, wherein the first position and the second position are respectively located at two ends of a maximum tracking distance of the optical lens in the direction along the non-optical axis.

5. An image pickup device, comprising:
an optical lens;
a driving unit, connected to the optical lens, configured to drive the optical lens to move from a first position to a second position in a direction along a non-optical axis;
a sensing element, configured to sense a beam that passes through the optical lens and that is transmitted in the sensing element to obtain a first image when the optical lens is located at the first position, and sense a beam that passes through the optical lens and that is transmitted in the sensing element to obtain a second image when the optical lens is located at the second position; and
a computing unit, connected to the sensing element, configured to compute a difference between the first image and the second image to obtain a depth-of-field data of either the first image or the second image.

6. The image pickup device according to claim 5, wherein the driving unit is a motor.

7. The image pickup device according to claim 5, wherein the computing unit computes the difference between the first image and the second image by computing a peak signal-to-noise ratio (PSNR).

8. The image pickup device according to claim 5, wherein the computing unit computes the difference between the first image and the second image by using a mean-residual normalized correlation method (ZNCC).

9. The image pickup device according to claim 5, wherein the first position and the second position are respectively located at two ends of a maximum tracking distance of the optical lens in the direction along the non-optical axis.

10. An electronic device, comprising:
a housing; and
an image pickup device, disposed in the housing, comprising:
an optical lens, at least a part of which is exposed out of the housing;
a driving unit, connected to the optical lens, configured to drive the optical lens to move from a first position to a second position in a direction along a non-optical axis;
a sensing element, configured to sense a beam that passes through the optical lens and that is transmitted in the sensing element to obtain a first image when the optical lens is located at the first position, and sense a beam that passes through the optical lens and that is transmitted in the sensing element to obtain a second image when the optical lens is located at the second position; and
a computing unit, connected to the sensing element, configured to compute a difference between the first image and the second image to obtain a depth-of-field data of either the first image or the second image.

11. The electronic device according to claim 10, wherein the driving unit is a motor.

12. The electronic device according to claim 10, wherein the computing unit computes the difference between the first image and the second image by computing a peak signal-to-noise ratio (PSNR).

13. The electronic device according to claim 10, wherein the computing unit computes the difference between the first image and the second image by using a mean-residual normalized correlation method (ZNCC).

14. The electronic device according to claim 10, wherein the first position and the second position are respectively located at two ends of a maximum tracking distance of the optical lens in the direction along the non-optical axis.

15. The electronic device according to claim 10, wherein the electronic device is a mobile phone, a personal digital assistant device, or a wearable device.
